(19) United States
(12) Patent Application Publication
(10) Pub. No.: US 2014/0269930 A1
(43) Pub. Date: Sep. 18, 2014

(54) EFFICIENT COMPOSITING OF MULTIPLE VIDEO TRANSMISSIONS INTO A SINGLE SESSION

(71) Applicants: John Robinson, South Riding, VA (US); Sree Kotay, Philadelphia, PA (US)

(72) Inventors: John Robinson, South Riding, VA (US); Sree Kotay, Philadelphia, PA (US)

(73) Assignee: Comcast Cable Communications, LLC, Philadelphia, PA (US)

(21) Appl. No.: 13/827,250

(22) Filed: Mar. 14, 2013

(51) Int. Cl. H04N 7/26

(52) U.S. Cl. CPC H04N 19/00545
USPC 375/240.24

(57) ABSTRACT

A plurality of different video transmissions may be sent over a network in a reduced definition mode which may be encoded on macroblock domains. The reduced definition video transmissions may be assembled into a composite having numerous thumbnails of reduced definition video transmissions on macroblock boundaries, without decoding the reduced definition video transmissions. These may be sorted and filtered and then combined into a single combined transmission (e.g., stream), which then may be decoded using, for example, a single decoder and displayed.

### BACKGROUND

Macroblocked video compression technology (such as A VC/H.264) is a technology used in delivering high quality video content while consuming minimal data bandwidth. Many consumer electronics devices today such as mobile phones, tablets and set top boxes have special purpose hardware dedicated to processing and decompressing such transmissions. However, decompressing this video content is computationally expensive on the rendering client device. Decompression of high definition (HD) video is typically done by special purpose hardware. In order to keep hardware costs low, many of these devices only have the ability to process a limited number of HD transmissions, usually a single HD transmission (e.g., stream). Decompressing each video transmission (e.g., (e.g., stream), and then attempting to combine the transmissions in a picture-in-picture fashion inside a display buffer requires several expensive decoders and enormous processing resources. As the number of video transmissions goes above two, this approach becomes cost prohibitive very quickly.

Limited decoder resources greatly constrain the products and services that can be developed for these devices. Accordingly, there is a need for improved systems, devices, and methods for delivering, managing, assembling, decoding, and displaying video, particularly HD video transmissions (e.g., stream).

### SUMMARY

The following summary is for illustrative purposes only, and is not intended to limit or constrain the detailed description.

In some embodiments, a plurality of different video transmissions (e.g., streams) may be sent from a central communication system (e.g., a server and/or headend) in both a full definition video mode (e.g., HD mode) and a reduced definition video mode (e.g., a thumbnail definition video). The reduced definition video mode may be variously encoded such as on macroblock domains. For example, there may be different reduced definition transmissions respectively for some or all of the full definition video transmissions. The reduced definition video transmissions (e.g., a thumbnail video stream) may be assembled while still in a compressed form into a composite having numerous video transmissions such as reduced definition video transmissions. The selection of which ones of the reduced definition video transmissions to be assembled in the mosaic or array of reduced definition videos may be determined based on criteria such as one or more of the following: user preferences, user subscribed packages, user favorites, ratings, and/or other filter options. Once selected, the video transmissions (e.g., reduced definition video transmissions such as thumbnails) may be combined while still in a compressed form into a single video transmission (e.g., stream) which, when decoded, provides a display of one or more composite arrays, mosaics, and/or groups of videos (e.g., thumbnail videos) each playing simultaneously on the same screen. For example, some number of separate reduced definition video transmissions may be combined into a single combined transmission (e.g., stream) and then output through, for example, one video decoder for display on a screen.

In additional embodiments, the combining of these separate video transmissions may be accomplished, for example, in such a way that the resulting output transmission (e.g., stream) will display a visually composited display of the separate transmissions when the single output transmission (e.g., stream) may be decoded. In one exemplary embodiment, the composition may be done by interleaving and compositing different macroblocks in macroblock domained videos. In this manner, a mosaic may be created which composites one or more videos (e.g., thumbnail videos) to create a composition of compressed video transmissions. This mosaic may be able to be decoded by, for example, a single video decoder.

In further embodiments, the structure and capabilities of macroblocked video compression technologies such as H.264 may be leveraged to combine a mosaic of compressed transmissions without the need to decode all of the transmissions prior to the combination of the thumbnail videos. For example, a H.264 transmission (e.g., stream) may include a sequence of frames with a number of different frame types with at least certain frames using block-oriented motion-compensated macroblocks. Some frames may represent a key frame in which an entire frame of video is represented while other frame types may describe small spatial changes in the video, e.g., relative to a base frame and/or relative to other frames. In these examples, by interleaving and manipulating the frame data from multiple video sources, a composite may be created from different transmissions to achieve a composition of the transmissions into a single output transmission (e.g., stream) that can be output to, for example, a single video decoder and decoded to produce an output video which is a mosaic of the input video transmissions (e.g., multiple thumbnail video streams).

As noted above, this summary is merely a summary of some of the features described herein. It is not exhaustive, and it is not to be a limitation on the claims.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures in which like numerals indicate similar elements.

FIG. 1 illustrates an example communication network on which various features described herein may be implemented.

FIG. 2 illustrates an example computing device that can be used to implement any of the methods, servers, entities, programs, algorithms and computing devices described herein.

FIG. 3 illustrates an example data center system.

FIG. 4 illustrates an exemplary algorithm for interleaving multiple video transmissions (e.g., reduced definition macro-block video streams) into a composite video transmission.

FIG. 5 illustrates an example where a multiple video transmissions are selected, composited, and displayed as a composited image.

FIG. 6 shows another application of the embodiments described herein where a full definition video image is composited with one or more reduced definition video images to create a picture-in-picture video image.

FIG. 7 shows yet another application of the embodiments described herein where the composited images are utilized for video conferencing.

FIG. 8 shows an exemplary flow diagram in accordance with an exemplary algorithm for implementing some of the embodiments described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized herein, and structural and functional modifications may be made, without departing from the scope of the present disclosure.

FIG. 1 illustrates an example communication network 100 on which many of the various features described herein may be implemented. Network 100 may be any type of information distribution network, such as a fiber, hybrid/fiber coax, internet, Internet, intranet, satellite, telephone, cellular, wired, and/or wireless, etc. Examples may be a wireless phone network, an optical fiber telecommunication network, a coaxial cable distribution network, and/or a hybrid fiber/coax distribution network. Such networks 100 may be configured to use a series of interconnected communication links 101 (e.g., coaxial cables, optical fibers, wireless, etc.) to connect multiple electronic devices 102 (e.g., computers, laptop, set top boxes, tablets, smart phones, televisions, terminals, networks, etc. remotely located at, for example, businesses, homes, consumer dwellings or other locations remote from the central communication system) to central communication system 103 such as a Internet, local office, server, internal and/or external network and/or headend. The central communication system 103 may transmit downstream information signals onto one or more the links 101, and the electronic devices 102 may have one or more communication devices to receive and process various signals from the links 101.

There may be one link 101 originating from the central communication system 103, and it may be split and/or repeated a number of times to distribute the signal to various electronic devices 102 in the vicinity (which may be many miles) of the central communication system 103. The links 101 may include components not illustrated, such as splitters, repeaters, filters, amplifiers, etc. to help convey the signal clearly. Portions of the links 101 may also be implemented with fiber-optic cable, while other portions may be implemented with coaxial cable, other lines, and/or wireless communication paths.

The central communication system 103 may include an interface, such as a termination system (TS) 104. More specifically, the interface 104 may be a cable modem termination system (CMTS), which may be a computing device configured to manage communications between devices on the network of links 101 and backend devices such as servers 105-107. The interface 104 may be as specified in a standard, such as the Data Over Cable Service Interface Specification (DOCSIS) standard, published by Cable Television Laboratories, Inc. (a.k.a. CableLabs), or it may be a similar or modified device instead. In other embodiments, the interface 104 may be a wireless receiver. The interface 104 may be configured to place data on one or more downstream frequencies to be received by modems at the various electronic devices 102, and to receive upstream communications from those modems on one or more upstream frequencies.

The central communication system 103 may also include one or more network interfaces 108, which can permit the central communication system 103 to communicate with various other external networks 109. These networks 109 may include, for example, networks of Internet devices/servers/locations, internet devices, Intranet devices, telephone networks, cellular telephone networks, fiber optic networks, local wireless networks (e.g., WiMAX), satellite networks, and any other desired network, and the network interface 108 may include the corresponding circuitry needed to communicate on the external networks 109, and to other devices on the network such as a cellular telephone network and its corresponding cell phones. Further, central communication system 103 may itself form a part of a larger communication network. In various exemplary embodiments, those networks may be a private network, the internet, and/or the Internet.

As noted above, the central communication system 103 may include a variety of servers 105-107 that may be configured to perform various functions. The servers 105-107 may themselves comprise other servers and/or load balancing networks. For example, the central communication system 103 may include a push notification server 105. The push notification server 105 may generate push notifications to deliver data and/or commands to the various electronic devices 102 in the network (or more specifically, to the devices associated with the electronic devices 102 that are configured to detect such notifications). The central communication system 103 may also include a content server 106. The content server 106 may be one or more computing devices that are configured to provide content to electronic devices. This content may be, for example, video on demand movies, television programs, songs, text listings, etc. The content server 106 may include software to validate user identities and entitlements, to locate and retrieve requested content, to encrypt the content, and/or to initiate delivery (e.g., transmission of content (e.g., streaming) to the requesting user(s) and/or device(s).

The central communication system 103 may also include one or more application servers 107. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide listings. Another application server may be responsible for monitoring user viewing habits and collecting that information for use in selecting advertisements. Yet another application server may be responsible for formatting and inserting advertisements in a video transmission (e.g., stream) which may be transmitted to the electronic devices 102. Although shown separately, one of ordinary skill in the art will appreciate that the push server 105, content server 106, and application server 107 may be combined. Further, here the push server 105, content server 106, and application server 107 are shown generally, and it will be understood that they may each contain memory storing computer executable instructions to cause a processor to perform steps described herein and/or memory for storing data and function in accordance with any of the algorithms described herein.

An example electronic devices 102a, (e.g., a cell phone, tablet, set top box, television, and/or laptop), may optionally include an interface 120. The interface 120 can include any communication circuitry needed to allow a device to communicate on one or more links 101 with other devices in the network. For example, the interface 120 may include a modem 110, which may include transmitters and receivers used to communicate on one or more of the links 101 and with the central communication system 103. The modem 110 may be, for example, a coaxial cable modem (for coaxial cable lines 101), a fiber interface node (for fiber optic lines 101), twisted-pair telephone modem, cellular telephone transceiver, satellite transceiver, local wi-fi router or access point, or any other desired modem device. Also, although only one modem is shown in FIG. 1, a plurality of modems operating in parallel may be implemented within the interface 120. For example, some of these modems may be wired, some may be wireless such as 802.11 and/or 4G, and others may be suitable to other technologies such as WiMax and/or fiber. Further, the interface 120 may include a gateway interface device 111. The modem 110 may be connected to, or be a part of, the gateway interface device 111. The gateway interface device 111 may be a computing device that communicates with the modem(s) 110 to allow one or more other devices in the electronic devices 102a, to communicate with the central communication system 103 and other devices beyond the central communication system 103. The gateway 111 may be a set-top box (STB), digital video recorder (DVR), computer server, or any other desired computing device such as a phone, tablet, and/or laptop. The gateway 111 may also include (not shown) local network interfaces to provide communication signals to requesting entities/devices associated with the electronic devices 102a, such as display devices 112 (e.g., televisions, tablets), additional STBs 112, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), wireless and/or wired security cameras, security sensors, etc.), landline devices 117 (e.g. Voice over Internet Protocol—VoIP phones), landline phones, security cameras, security devices, and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11, IEEE 802.15), analog twisted pair interfaces, Bluetooth interfaces, and others.

FIG. 2 illustrates general hardware elements that can be used to implement any of the various computing devices discussed herein. The computing device 200 may include one or more processors 201, which may execute instructions of a computer program to perform any of the features described herein. The processor may include one or more decoders for video compression and/or decompression. In some devices such as cellular telephones and/or tablets, the processor 201 may include a single decoder for video. The instructions for the processor 201 may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired storage medium. Instructions may also be stored in an attached (or internal) hard drive 205. The computing device 200 may include one or more output devices, such as a display 206 (e.g., an external television), and may include one or more output device controllers 207, such as a video processor (e.g., a macroblock video decoder such as AVC/H.264). There may also be one or more user input devices 208, such as a remote control, keyboard, mouse, touch screen, microphone, etc. The computing device 200 may also include one or more network interfaces, such as a network input/output (I/O) circuit 209 (e.g., a network card) to communicate with an external network 210. The network input/output circuit 209 may be a wired interface, wireless interface, or a combination of the two. In some embodiments, the network input/output circuit 209 may include a modem (e.g., a cable modem, fiber modem, and/or wireless modem), and the external network 210 may include the communication links 101 discussed above, the external network 109, an in-home network, a provider's wireless, coaxial, fiber, hybrid fiber/coaxial distribution system (e.g., a DOCSIS network), and/or any other desired network. Additionally, the device may include a location-detecting device, such as a global positioning system (GPS) microprocessor 211, which can be configured to receive and process global positioning signals and determine, with possible assistance from an external server and antenna, a geographic position of the device.

The examples in FIG. 1 and FIG. 2 may be modified in various ways. For example, modifications may be made to add, remove, combine, divide, etc. components of the computing device 200 and/or communication network 100 as desired. Additionally, the components illustrated may be implemented using basic computing devices and components, and the same components (e.g., processor 201, ROM storage 202, display 206, etc.) may be used to implement any of the other computing devices and components described herein. For example, the various components herein such as those in FIG. 1 may be implemented using computing devices having components such as a processor executing computer-executable instructions stored on a computer-readable medium, as illustrated in FIG. 2. Some or all of the entities described herein may be software based, and may co-exist in a common physical platform (e.g., a requesting entity can be a separate software process and program from a dependent entity, both of which may be executed as software on a common computing device).

One or more aspects of the disclosure may be embodied in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of computer executable instructions and computer-usable data described herein.

FIG. 3 illustrates an example data center which may be included as part of the central communication system 103. As illustrated, a central data store 300 may store content, such as video on demand, movies, etc., that is made available for download and/or transmission to users. To handle the various requests and send requested content to users, the data center may employ multiple computing device nodes 301. Each node 301 may handle a subset of the user requests for content, or service a subset of users. In some embodiments, one of the nodes 301 may be designated as a master node for the data center, and may handle additional responsibilities, such as managing the load responsibilities of the various nodes.

Although FIG. 3 shows a single data center, any single data center can become overwhelmed if a large enough number of users are to be serviced. So to address that, a variety of data centers may be used to offer the content. Each data center may include discrete management hardware and/or software for managing a group of clients for requests. The grouping can be done based on a variety of factors, such as geography, subscription level, user ID, etc. In some embodiments, the group of devices serviced by a datacenter may be based on data latency, where a datacenter group includes clients that are serviceable by a particular source device within a predetermined amount of latency or delay in signal transmission. For example, one data center may be located on the West coast of the United States, and service requests coming from that portion of the country, and another data center may be located on the East coast, servicing requests from that different portion of the country.

In accordance with some embodiments contained herein, a plurality of thumbnail video transmissions may be delivered from the central communication system 103 to the electronic device 102 via the links 101. The electronic device may include a processor 201 programmed to perform selection of a plurality of the video transmissions based on some filtering criteria as discussed herein. Prior to decompressing, the video transmissions (e.g., thumbnail video configured as streams) may then be parsed into individual frames and/or macroblocks. In certain embodiments, some or all of these individual frames and/or macroblocks from different transmissions may then be sorted or arranged into a composite video output transmission (e.g., stream) of compressed data. This composite video transmission (e.g., stream) may then be sent through a video decoder such as decoder 207 to a display device (e.g., 206). In this manner, a video decoder can decompress multiple video transmissions simultaneously and display an array or mosaic of different video transmissions (e.g., thumbnail videos). In these embodiments, the filtering and sorting of macroblocked video compression content enables an innovative delivery mechanism of multiple video transmissions (e.g., thumbnail transmissions configured as streams) using a single decoder. For example, using a video encoding/decoding technique such as H.264, it is possible to organize the video data as macroblocks and then organize the macroblock content in terms of a sequential set of frames and/or macroblocks that are used to capture motion, tracking information, and other related data. By analyzing how the video is represented in these macroblocks, the data from different video transmissions may be combined to allow multiple video transmission (e.g., thumbnail videos delivered as streams) sources to be assembled into a mosaic and/or array of different video transmissions while the data remains compressed and encoded. Processing the compressed and encoded data is far more efficient in terms of processing resources and can eliminate and/or reduce the need for having a different decoder for every different thumbnail video transmission (e.g., stream). Where one or more additional video decoders are available, the mosaic may be combined with one or more additional video streams either before or after decoding. For example, a mosaic of reduced definition video streams may be combined with one or more high definition video streams. In one exemplary embodiment, before decoding various macro blocks in the composited video stream may be replaced and/or substituted in its initial composition with some and/or all macro blocks from a high definition video stream. In this manner, a high definition video stream way be inserted into a composite of low definition video streams and/or a low definition composited video stream may be inserted into a high definition video stream. Where one or more an additional decoders are available, the compositing may be done before and/or after decompression. For example, a number of thumbnail videos may be composited before decoding and then one or more high definition video transmissions may be added using different decoders either before and/or after the composited and high definition video streams are decoded. In still further embodiments, macro blocks of the high definition video stream may be substituted into the mosaic without decoding thus allowing a high definition video stream of varying degrees of resolution to be incorporated into the mosaic.

In accordance with some aspects, different video transmissions may be combined without decoding and/or decompressing such that the output transmission (e.g., stream) contains different video sources and/or transmissions. These different video sources and/or transmissions may be composited and/or combined (e.g., on full and/or partial macroblock and/or frame boundaries) in such a way that when the composited and/or combined video transmission (e.g., stream) is input into a decoder, all of the different thumbnail input video transmissions may be visually composited when the video is output from the decoder. For example, three different thumbnail video transmissions from three different servers may be combined without decompressing so that the output transmission (e.g., stream) has three different video sources combined. This example, may generate an output video display or presentation having three video transmissions (e.g., thumbnails videos transmitted as streams) being simultaneously displayed on the screen using a single decoder.

While the video transmissions in many examples may be sent from a centralized location such as communication network, the transmissions (e.g., thumbnail video transmissions) may also be sourced from a local location such as a DVR storage location such as a computer memory and/or disk. For example, in some exemplary embodiments, a thumbnail video guide may be assembled from videos stored on the DVR storage device.

If one were to attempt to obtain, for example, a thumbnail video guide through combining or compositing in an upstream centralized facility, every user that wanted a mosaic of different thumbnails would have to consume bandwidth from the upstream centralized facility. For example, if a user wanted a, b, and c video transmissions (e.g., video thumbnails) the system would have to have one whole transmission (e.g., stream) delivered from the upstream centralized facility for that user with a, b, and c. If another user wanted a, b, and e, that user would have to have a whole other transmission (e.g., stream) delivered from the head end having a mosaic of a, b, and e, which increase the bandwidth for every user that wanted a different combination of video transmissions.

Such a system has scalability challenges where many different users are present. By being able to achieve the filtering and combining on the downstream (e.g., device side/level), each user can have different combinations (e.g., User 1: a, b and c; User 2: a, b, and e, etc.) using the same bandwidth requirements. Further, this architecture may be scalable to many users occupying the same bandwidth. Further, the architecture in accordance with examples herein allows each user to create a customized mosaic of videos with minimal hardware configurations such as those with a single decoder and/or a general purpose processor (without any video decoder). For example, the mosaics and/or high definition video transmissions described herein may be decoded in software (e.g., using general purpose computer portions of processor 201). In these embodiments, decoding is achieved without any special hardware decoding units. As mobile device costs (e.g., tablet or smart phone costs) are driven down, a solution such as that discussed herein can achieve substantial savings while delivering many new features and capabilities.

The central communication system 103 shown in FIG. 1 may output digital media content transmissions in either full resolution and/or reduced resolution mode. In some embodiments, there are a plurality of different video transmissions sent from the central communication system 103 in a plurality of different resolutions. For example, video transmissions may be sent in a full definition mode (e.g., HD mode) and a reduced definition mode (e.g., thumbnail definition mode) from the central communication system 103 over links 101 to the electronic device 102. For example, where television channels are being sent, (e.g., NBC, CBS, and ABC) each channel may be sent in both a high definition transmission (e.g., stream) and a reduced definition video transmission (e.g., thumbnail definition video sent as a stream). The video transmission may be encoded using any suitable compression algorithm such as a compression algorithm that operates on macroblock domains as for instance using a coding scheme such as H.264. In other embodiments, there may be different reduced definition transmissions for some or all of the full definition video transmissions. Where a reduced definition transmission (e.g., a thumbnail video sent as a stream) is not available for certain ones of the full definition video transmissions, the reduced definition video (e.g., thumbnail video sent as a stream) may be replaced with a capture of a frame from the high definition video transmission, reduced in resolution to a thumbnail video image, and then repeated for later decoding. In this manner, thumbnail video transmissions received over the links 101 may be assembled into a composite video transmission (e.g., using the algorithm as shown in FIG. 4) into numerous thumbnails of reduced definition video transmissions (e.g., see thumbnail video transmissions shown in FIGS. 5-7) using, for example, gateway device 111 and/or processor 201.

The video transmissions (e.g., reduced definition video transmissions) may be selected using any suitable technique. For example, the device may start in an initial state where all reduced definition video transmissions are displayable. In this example, they may appear as shown in FIG. 5. A user may scroll left, right, up, and down via a remote control and/or a swipe of his/her finger on a touch screen control device. If the user desires to filter his/her content, the user may select one or more filter options which may be via a pull down menu and/or a direct action button on the remote control cell phone and/or tablet. For example, the user may have favorite channels enabled and the video transmissions may be filtered to select only the user's favorite channels in accordance with the user's favorite channel list. In this manner, the programs shown on the screen in FIG. 5 reflect video transmissions that are in the user's favorite channels list. Alternatively and/or additionally, the user may select genres such as action, western, sports, etc. as the filtering criteria. Additionally and/or alternatively, the user may select filters such as geography (e.g., USA, Europe) and language (e.g., English, German, French) as the filtering criteria. Additionally and/or alternatively, the filtering of which videos transmissions may be combined into the array of videos such as that shown on FIG. 5 may be done based on entitlements or service tiers to which the user has subscribed. Based on one or more selection criteria, a video transmissions may be filtered and then assembled into a mosaic using a suitable device such as gateway device 111 and/or processor 201. In exemplary embodiments, the transmissions need not be decoded. The video transmissions in these embodiments (e.g., a reduced definition video transmission such as a thumbnail video configured as a stream) may be assembled using any suitable technique such as those described herein performing assembly on full and/or partial frame and/or macroblock boundaries. In this manner, decoding of the transmissions prior to assembling the mosaic is eliminated and customized composite thumbnail video steams may be assembled at the electronic device 102 using minimal hardware resources.

These transmissions may then be processed for presentation and/or display using device controller 207 such as an H.264 decoder. Thus, the customized mosaics may be generated and/or sorted based on user preferences, user subscribed packages, user favorites, ratings, and/or other filter options into one or more composite displays showing several reduced definition video transmissions. For example, some number of separate reduced definition video transmissions may be combined into a single combined transmission (e.g., stream). In additional embodiments, the combining of these separate video transmissions may be accomplished, for example, in such a way that the resulting output transmission (e.g., stream) may comprise a composited transmission of the separate video transmissions (e.g., thumbnail video streams) when the single video output transmission (e.g., stream) is decoded using, for example processor 201 and/or device controller 207.

In one exemplary embodiment, the composition may be done in a macroblock domain which can create a composition of compressed transmissions. For example, a macroblock is a component of many video compression schemes which is derived from using a discrete cosine transform applied to all and/or parts of individual video frames.

Macroblocks may be comprised of two or more different blocks of pixels. For example, MPEG 2 codecs typically encoded in macroblocks of 8×8 pixels and MPEG 4 codecs typically define macroblocks in 16×16 pixels. These macroblocks may be further broken down into 4, 8, or 16 pixels by 4, 8, or 16 pixels. Each marcoblock typically contains a luminance block (e.g., Y), a blue color difference block (e.g., Cb), a red color difference block (e.g., Cr) and other information such as address of block in image, type of macroblock (e.g., intra-frame, inter-frame, etc.), quantization value, motion vector, bit mask for coded block patterns, etc. In exemplary embodiments, by parsing the thumbnail video images and then interleaving the frames and/or macroblocks and modifying the address and/or location of the frames and/or macroblocks in the output video transmission (e.g., stream), the frames and/or macroblocks can be transposed in position on the output video transmission (e.g., stream) so that all of the reduced definition videos (e.g., thumbnail videos sent as streams) can be displayed simultaneously on the output video transmission. By adjusting the various different offsets and/or addresses for the frames and/or macroblocks, the frames and/or macroblocks of the various thumbnails video transmissions may be arranged so that they are offset at different distances from, for example, a side and a top edge of the output video screen. In this manner, in some embodiments, the different thumbnail video transmissions do not overlap. Rather they may be configured to display next to each other in an array and/or mosaic. Additionally, as shown in FIG. 6, it is possible to replace some of the macroblocks of one full definition video image with macroblocks of a thumbnail video image to create picture in picture arrangements. In still further embodiments, such as that shown in FIG. 7, some thumbnail videos may be of different dimensions than other thumbnail videos and the geometric area of a video transmission (e.g., stream) may be taken into account when determining the different offsets and/or addresses to be assigned to the thumbnail video transmissions. In still further embodiments, the thumbnail videos may overlay a high definition video stream with any degree of transparency.

In additional embodiments, the structure and capabilities of macroblocked video compression technologies such as H.264 may be leveraged to combine a mosaic of compressed transmissions without the need to decode all of the transmissions. For example, an H.264 transmission (e.g., stream) may include a sequence of frames with a number of different frame types. In exemplary encoding, some frames may represent a key frame in which an entire frame of video is represented while other frame types may represent small spatial changes in the video relative to other frames such as a base frame. For example, in certain video encoding codecs such as H.264, some frames may be referred to as an “I” frame (intra coded image frames) which permits access to still frames in a clip, some frames may be referred to as “P” frames (predicted image frames) which are predicted from previous “I” frames, and some frames may be referred to as “B” frames (bi-directionally interpolated image frames) which may be interpolated from previous or following P or I frames. By interleaving and manipulating (e.g., interleaving frames and/or macro blocks and/or translating addresses) the macro block and/or frame data from multiple video sources may form a composite from the same and/or different transmissions to achieve a visual composition of the transmissions into a single output transmission (e.g., stream) that can be input into a video decoder. Some and/or all of the frames from one of the video transmissions by be adjusted in address and location to have the frames offset from frames from a different video transmission. For example, one composite video transmission may be assembled by translating the address and/or location data associated with select frames and/or macro blocks from each of the different video transmissions (e.g., thumbnail videos). This may be accomplished in any suitable manner such as, for example, by parsing the video transmissions from the signals on the links 101 in processor 201 and then reassembling the transmission prior to sending these translated full and/or partial frames/macroblocks into decoder/device controller 207 for decoding and decompressing the composited video for display on a display device e.g., display device 112.

Video transmissions in some embodiments may contain a set of frames that are interleaved, which may include different types of frames. For example, there may be I frames, b frames such as backwards predictor frames and/or p frames such as forward frames. Additionally, one or more frames may be variously configured such as being divided into a set of macroblock data. The macro blocks may be variously configured such as being transformed and/or compressed using any suitable technique such as a cosine transform to compress data. Some embodiments organize multiple input transmissions by translating addresses and frame/macroblock location information to form a composite video using frame and/or macroblock data within frames of the different video transmissions (e.g., thumbnail video transmissions). This may be accomplished in some embodiments without decoding the transmissions by reordering the frame and/or macroblock data and translating the location information associated with that frame and/or macroblock data without decoding the video data. This reordering and address translating can be accomplished, for example, on a standard central processing unit (CPU) without the need for decompression. For example, once the choice is made as to which video transmissions are to be displayed (e.g., via filtering and then focusing on a displayable portion of the filter results), the parsing and the reordering of the frames can be done on the CPU. This approach is very portable between platforms and can be accomplished efficiently on the general purpose computing. Once the video transmission is reassembled with the video transmissions (e.g., thumbnail videos) translated in location across the effective target display area of the display device 206, the composited transmission (e.g., stream) can then be decompressed in the normal fashion using, for example, video decoder 207.

In one aspect, the parsing and reordering function may be thought of as being analogous to building blocks (e.g., a child's building blocks) of data where each block represents a frame and/or macro block of a video transmission (e.g., a thumbnail video configured as a stream), and the address and translating functions may be thought of as moving a block from one location in the stack of blocks to another location. These blocks of data (e.g., frames and/or macroblocks) may be kept intact with the reordering and translating functions being accomplished by reordering and/or translating the frame and/or macroblocks and any associated address modifications. In this manner, some embodiments move the blocks of data (e.g., macroblocks and/or frames) around from multiple video transmissions in such a way that a decoder, when decoding the composited video steam, still interprets the combined transmission (e.g., mosaic of thumb nail videos sent as streams) to have all the blocks organized the right way to show the array of thumbnail videos such as those shown in FIGS. 5-7. In certain embodiments, there may not be a need to decode and/or “crack open” certain macro blocks and/or frames in accordance with some embodiments herein. As discussed above, the location of the blocks on the screen of the display device can be adjusted using reordering and address translation without the need to decode/decompress the individual frames and/or macroblocks. In these embodiments, the video data itself (e.g., data that contains the pixel data for the dots on the screen, color information, etc. such as frames and macroblocks) can remain intact without a need to decode this data. Meanwhile the reordering and screen address translation ensures that all of the video transmissions can be displayed simultaneously. In certain embodiments, it is desirable to use logic/processor/computer (e.g., processor 201) to select the individual thumbnail video transmissions in accordance with a filter criteria and then to parse and reorder the structural information associated with the frames and macroblocks to shuffle around frames and/or macroblocks associated with different video transmissions in order to form a viable, single transmission (e.g., stream) output, that can be input into a decoder such as device controller 207. The discrete cosine transform (DCT) blocks may then be decompressed within the video decoder 207 and rendered on the display device 112. Embodiments use the structural data, address, macroblock and/or the frame information to move blocks around to create a mosaic of thumbnails that can be input into a standard H.264 video decoder.

An exemplary implementation may allow translation and composition along full and/or partial frame and/or macroblock boundaries. An alternate exemplary implementation would enable translation and scaling, either (to reduce computational requirements) at power of 2 scales and on macroblock boundaries, or on boundaries that are not macroblock boundaries. For example, a 4×4 macroblock size may be interpolated into a 16×16 macroblock size. Further, embodiments include DCT scaling, motion vector scaling (spatially and/or temporally), and/or other scaling operations in order to create different effects on the composited image. In some embodiments, it may be desirable to zoom on certain thumbnail videos to a first size, larger than the original size, and/or to switch to a high definition video transmission (e.g., stream) that corresponds to the thumbnail video steam. In this manner, the user may resize individual video transmissions within the mosaic and/or change the display characteristics of the mosaic to include more or less video transmissions.

Referring to FIG. 4, an exemplary embodiment may be configured to combine any number of video streams such as the three video transmissions of encoded digital video into a single transmission (e.g., stream) which arranges the frames and/or macro blocks as video transmissions (e.g., thumbnail videos° dimensionally spaced on a single screen when decoded by a video decoder (e.g., an H.264 video decoder) and thereafter presented and/or displayed. In some embodiments, a large number of thumbnail video transmissions (e.g., 50, 100, 200, 500 or more) may be filtered by a user to a much smaller number of video transmissions (e.g., thumbnail videos), e.g., 4, 8, 10, 20, 30, 40, and/or 50 for simultaneous display on a single and/or multiple display device(s). In this example, a filtering process (e.g., based on favorite channel, theme, subscription level, program guide selections, VOD clips, etc.) may reduce the number of desired thumbnail video transmissions from hundreds of available steams to just three thumbnail video transmissions. The filtering in this embodiment may have occurred using, for example, the processor(s) 201 based on, for example, user specified criteria. In this example, the electronic device 102 may be a tablet computer or cellular telephone. In FIG. 4, the three different transmissions, e.g., transmission 1 400, transmission 2 410, and transmission 3 420 from, for example, the same or three different sources may be selected. In some embodiments, the sources may be locations such as the external network 109, locations on the central communication system 103 and/or any location on the network 100. The trapezoids shown as transmissions in FIG. 4 may represent full and/or partial frames and/or macroblocks from three different video transmissions 400, 410, 420 (e.g., thumbnail videos). For example, trapezoids 401-407 may be associated with the first transmission 400 (e.g., a first reduced definition video stream); trapezoids 411-416 may be associated with the second transmission 410 (e.g., a second reduced definition video stream); and trapezoids 421-427 may be associated with the third transmission 420 (e.g., a third reduced definition video stream). FIG. 4 represents an exemplary embodiment with respect to how various frames and/or macroblocks may be assembled into a single composite output transmission (e.g., stream). Each one of the trapezoids shown in FIG. 4 may represent a frame and/or macroblock which typically contain the data discussed above in, for example, a DCT compressed format. At a first level, the frames and/or macroblocks from the different thumbnail video transmissions may be interleaved and may be translated in location/address either directly or through this interleaving process, thus creating a composited stream which may be decoded, for example, using a single decoder.

Additionally, in exemplary embodiments, within the frames (trapezoids in FIG. 4) there may be various macroblocks. In certain embodiments, it may be desirable to parse the frame into discrete macroblocks, and then shuffling/interleaving the macroblocks to produce a single composited output transmission (e.g., stream) of thumbnail videos. Again, the macroblocks from the different thumbnail video transmissions may be offset in location on the output screen. Frames may be configured from one or more macroblocks. Further, in some embodiments, only portions of frames and/or macro blocks may be assembled (e.g., interleaved and/or translated) into the composite. For example, in exemplary systems each frame need not contain all the color data for a transmission (e.g., stream). There may be different kinds of frames in accordance with various digital transmission/encoding mechanisms such as H.264. In any event, the frames in the example shown in FIG. 4 typically include DCT compressed image data for the given frame. In some embodiments, a simplified approach is to simply reorganize/translate/interleave the frames to achieve offsets of the thumbnail video transmissions to generate the composited thumbnail video output transmissions. In other embodiments, it may also be desirable to reorganize/translate/interleave and/or address translate the macroblocks depending on the digital transmission standard (e.g., H.264) in order to construct a sequence to produce a suitable output such as that described in FIGS. 5-7. With respect to this example, such a sequence may be configured in accordance with the H.264 standard to render the composite thumbnail video image shown in FIGS. 5-7.

While many examples only require frame interleaving, in some situations where there is a desire to have some overlapping thumbnail video and/or picture-in-picture video in the visually composited output transmissions, it may be desirable to utilize macroblock interleaving either in addition to or instead of frame interleaving.

In one exemplary embodiment, a video transmission (e.g., thumbnail videos) of available channels is distributed over an IP network. The electronic device 102 (e.g., a tablet or smart phone) provides a video channel guide showing live video of either all or a subset of the channels based on a filtering scheme as discussed herein. See, for example, FIG. 5. In this example, the user interface may be configured to allow a user to scroll through some or all channels (e.g., a filtered subset of channels) and see a thumbnail video and/or a thumbnail video preview (e.g., VOD preview) of what is actually on that channel. Using embodiments of the present invention, a thumbnail video program guide is made possible to enable simple and easy selection of video content from sources anywhere on Network 100 using thumbnail videos of that content. Such a program guide may be enabled even on electronic devices 102 with modest processing power such as a tablet computer or smart cellular telephone such as an I-phone and/or android based telephone.

For example, a user may create a custom thumbnail video program guide and/or may have a predetermined thumbnail video program guide based on an available channel map, entitlements and/or a subscriber level. In one example, a premium subscriber may have a premium channel thumbnail video guide while another subscriber may have a base level thumbnail video guide showing a more limited subset of channels and/or VOD content. Devices configured for children may have a thumbnail video guide based on parental control settings, children categories, and/or theme/content designations.

In certain embodiments, it may be desirable to use the macroblocks to do scaling by interpolating the data to allow instant focus points by expanding some of the thumbnail video feeds. These embodiments would allow a user of an electronic device 102 (e.g., a tablet) to zoom in on an area of the mosaic without having to decode the full resolution video feed corresponding to the thumbnail video. For example, in exemplary embodiments, a thumbnail video feed may be extracted from the macroblocks, scaled, and output on the display device in expanded mode such as 2×, 3X, or 4X. This allows the user to see the video feed in a larger window. In this embodiment, the other windows may then be adjusted in boundaries/address/offset to surround the zoomed thumbnail video and/or the zoomed thumbnail video may overlay the other thumbnail images. In some embodiments, it may be desirable to reorganize the other thumbnail videos around the zoom image so that the user may expand each thumbnail video by tapping on the video (or selecting in another manner) and return the thumbnail video to its original size by again tapping (or selecting in another manner). One tap may zoom, a second tap may return to original size, and a double tap may switch the display to the full high definition video transmission (e.g., stream) and occupy all of the display.

Further embodiments allow a reduction in memory bandwidth to the video decoder, and a reduction in fill-rate requirements in the user interface by efficiently compositing the thumbnail video as discussed herein. In exemplary video thumbnailing devices described herein, it is possible to efficiently and simultaneously retrieve video content from many different sources such as QAM (given multiple tuners) or over IP. Embodiments herein allow a user to have a live grid guide or live gallery of thumbnail video channels presented to them simultaneously all from different video sources such as shown in FIG. 5. These video sources may be presented in a mosaic with devices that have a single hardware video decoder or a limited number of video decoders, or even no video decoder at all.

Conventionally, program guides are static with each program shown as a textual representation. In some cases the program guide has a single program shown in the upper left hand corner of the screen or displayed under the program guide. These representations are very limiting. Embodiments herein allow a program guide to be a video based program guide with multiple thumbnail videos in an array showing the user the video available for selection at that time. The array of the programs/channels shown in the thumbnail video guide may be dynamically selected locally. The user may then scroll through the array of thumbnail videos by scrolling up, scrolling down, scrolling left, scrolling right, and/or moving at a diagonal. These actions may be controlled via any suitable user interface such as swiping the screen. The thumbnail videos shown on the display device 206 may or may not be first filtered based on any suitable criteria discussed herein and then the videos may be further filtered based on screen space. For example, where the thumbnail videos are filtered such that the output of the filtering operation produces too many thumbnail videos to fit on the screen, the screen may be arranged to display only the most popular or most watched thumbnail videos on the display area with other thumbnail videos moved off of the visible area. The criteria for determining which videos are shown on the active area of the screen and which videos are off the active area of the screen may also be determined by advertising revenue and/or other criteria such as owner and/or source of the content. Further, thumbnail video transmissions from channels and/or programs frequented by the user may appear on the first active screen and other programs and/or channels rarely accessed may appear on other screens. A user may zoom one or all of the programs on a screen to allow easier viewing. For example, if the filter criteria only determines that four channels are relevant, the thumbnail videos for these four channels may be shown at a higher zoom such as 4×, 8×, 16×, 32×, and/or 64× zoom as opposed to the original thumbnail resolution.

In some embodiments, a user may quickly scroll through the thumbnail video steams to determine which channels are on commercial break and which channels are not on commercial break. The user may designate certain channels for hot swapping and/or to appear on a hot swapping thumbnail video guide page. The user could zoom to watch multiple channels at once and tap to turn on or off the sound from each thumbnail video. In certain embodiments, the user could control the sound from each video simultaneously to increase or decrease the sound from one or more thumbnail videos. For example, an equalizer slider sound control may appear on the display beneath the thumbnail videos. Additionally, the user could select a thumbnail video, zoom to that video, and/or go to full screen on that video. With the thumbnail video guide, there may be any number of user interfaces including user interfaces such as those used on conventional program guides. For example, each of the textual boxes on a conventional program guide may be supplemented with video transmission (e.g., a thumbnail video configured as a stream) from the associated channel. Rather than scrolling through hundreds of channels with cryptic names and waiting for the tuner to switch to that channel, the present video thumbnail guide lets a user scroll through thumbnail videos of the content then appearing on the channels without any significant delays. It enables the user to see immediately which program is on a commercial break and which program is not on a commercial break. Boxes could be color coded where the program is in a different language.

With respect to VOD assets, the thumbnail video guide disclosed herein allows a user to scroll quickly through hundreds of available videos and/or previews and select the ones that look interesting. Clicking once on the thumbnail video may bring up associated descriptions, purchase information, subscription offers, advertisements, links to more information, zoom of the video, and/or other similar associated information. A first “tap” on the thumbnail (or other suitable icon) may bring up a first level of information and a second “tap” on the video thumbnail (or other suitable icon) may bring up a second level of information. In devices that are multi-touched enabled, an expansion of moving two touch locations apart on the screen may cause the processor 201 to either expand and interpolate the existing video to a larger size and/or switch to the full definition video transmission (e.g., stream). Thumbnail video program guides in accordance with some embodiments discussed herein, enables a service provider to distinguish its offerings by having video thumbnails of programs and VOD content instead of uninteresting static screens containing textual information on numerous programs. For example, where videos may be viewed and/or purchased from different sources, the use of thumbnail video allows one content provider's offerings to stand out with respect to offerings from other content providers. Content providers who are enabled to provide thumbnail video transmissions along with full high definition video steams will have video appear in the guide for their programs while other content providers will be limited to static program guide transmissions. A single program guide may inter mix thumbnail video guide channels with static guide channels.

The use of thumbnail videos may be accessible through a computer program implementation (e.g., Java) implemented on standard browser technology. The browsers may assemble the thumbnails based on thumbnail video transmissions from numerous content providers disbursed throughout the network 100 such as the Internet. This enables a universal thumbnail video enabled program content selection mechanism for any available content on the network 100 such as the Internet. The thumbnail videos may include select program guide information such as rating, theme, textual description, language, short and long descriptions, pricing information, provider information, actors, links to one or more full HD transmissions associated with the thumbnail video, and/or entitlements including geographic based entitlements. This information may be provided in a standardized interface (e.g., a standardized API interface) allowing any thumbnail video enabled browser/program guide to access the information. Using this interface, users would be enabled to search, sort, display, and view/purchase from any source whatsoever.

In still further embodiments, a video search engines may employ thumbnail videos in place of the static frame grabs used in video search engines today such as those made by different video search engine companies (e.g., Google). Currently, a keyword search for various videos produces a static screen or at most one thumbnail video that is active. Embodiments of the present invention would allow all of the video search results to be playing in thumbnail videos directly on the search engine. Thus, the user can monitor 10's or even hundreds of video results as they are simultaneously playing on the browser window. In exemplary embodiments, sound may only be enable for a video over which, for example, the cursor was positioned. On a typical video search engine, up to 80 static video grabs are displayed on a 30″ screen, or 160 on a double 30″ screen in a dual monitor configuration. Under examples of the present invention, video returned by the search engine may be enabled to be playing simultaneously (e.g., as thumbnail video streams) using a standard browser implemented on a standard laptop, tablet, and/or smart cellular phone. The user may then select the video based on much more information. It also eliminates the need for the user to go through and hover over each video in order to see the video streamed. The search engine may transmit (e.g., stream) thumbnails of all videos in its database and/or transmit (e.g., stream) thumbnail videos of the most popular videos and then steam additional thumbnail videos from less popular searches in response to an individual search request.

Again referring to FIG. 5, the thumbnail videos may appear as two dimensional and/or three dimensional images. In the example of FIG. 5, the thumbnail videos may be overlaid on a three dimensional carousel with a curvature. The carousel may be spun as discussed with a swipe of a finger and/or other user interface. Further, the carousel may be paged up and/or down by swiping up and/or down (or using some other user interface to control movement). In program guides associated with some embodiments, there may be no need for any channel and time concepts in the program guide. The program guide may be accessed using thumbnail videos from a plurality of simultaneously active videos.

The thumbnail video images may also be displayed in a 3D program guide. In this example, a user may select videos from the guide and these videos may rise out of the guide and zoom toward the user. Further, the supplemental information associated with the thumbnail video feeds may be displayed three dimensionally.

In still further embodiments, the thumbnail video windows shown in FIG. 5 may be from security cameras. These video feeds may be handled in the same manner as discussed above for other video feeds. In some embodiments, the video feeds for the security system may be sourced from wireless devices 116 and/or landline devices 117. Using embodiments discussed herein, a security system does not require an expensive display station to decode and display all of the different camera feeds. Instead, the security officer may monitor his/her security cameras using a low cost tablet, laptop, or cellular phone. Each feed may be combined into a mosaic as discussed herein and displayed on a screen of combined thumbnail videos. The cameras and/or a centralized station may be configured to produce full definition security videos and reduced definition security videos. For example, the reduced definition videos (e.g., thumbnail videos configured as streams) may be created by dropping macro blocks from the frames to reduce the number of pixels rendered. The thumbnail videos and high definition videos may then be streamed to a display device such as an tablet computer. The user may then filter the feeds as discussed above, scroll through the security feeds, and/or expanded and/or reduced the video feeds as in the examples discussed herein. Embodiments described herein substantially reduce the costs of video security systems.

With reference to FIGS. 6-7, in a video oriented product such as video conferencing, many times it is desirable to have a user interface composited or combined with one or more video transmissions. However, this is made difficult or computationally expensive where only a single decoder is present. In accordance with the present disclosure, a video transmission (e.g., stream) that comprises an interactive user interface may be combined with multiple other video sources using video transmissions (e.g., thumbnail video transmissions) even for hardware constrained devices such as cell phones and/or tablet devices. Thus, lower resolution transmissions may be overlaid onto higher resolution video transmissions and assembled in accordance with the user's preferences. For example, a single decoder can be used to decode one, two, three or more video conference participants and have all of these overlaid on other higher resolution transmissions. Further, users may select a reduced resolution transmission and switch to a higher resolution transmission which may also be sent in tandem with the lower resolution transmission and have the same and/or substantially similar content. A higher resolution video transmission may be converted into a lower resolution video transmission by selectively dropping frames and/or macro blocks. The transmissions may be based on cloud-based user processing (e.g., interface) and/or video picture-in-picture applications. Thus, even using a single decoder, multiple video transmissions in a video conference may be decoded such as those shown in FIGS. 6 and 7. The applications include PIP and/or video conferencing applications. In exemplary applications, such as video conferencing, many different video sources need to be provided to the consumer. The local camera may be overlaid on top of the remote video display. See FIG. 6. In multi-party video conferencing, the video transmissions from many different participants may need to be combined visually. Aspects of the present disclosure such as the examples discussed herein allow this functionality to occur using a single hardware video decoder by compositing the thumbnail videos prior to decoding.

With respect to video conferencing, a similar situation arises where there are multiple video sources. The example shown in FIG. 6 shows a picture-in-picture environment such as a point-to-point video conference with a remote side and a local side. In this example, there are two videos being decoded, two videos being displayed and potentially only one decoder. In this example, the two videos may be overlapping in the picture. Using embodiments described herein, multiple sources may be combined prior to decoding in an efficient manner such as combining multiple sources, like the local camera and a remote video. The local camera video as well as the remote camera video may be interleaved on a frame and/or macroblock level to produce the combined image shown on a single decoder without the need to decode the video prior to the combining.

The example shown in FIG. 7 may be variously configured. In one exemplary embodiment, FIG. 7 shows a multiparty teleconference. In this case, a single decoder on, for example, a cell phone or tablet, allows the display of multiple parties from multiple sources that are composited and/or interleaved locally before the transmissions are decompressed.

Referring to FIG. 8, an exemplary algorithm in accordance with embodiments herein is shown and described. In accordance with this exemplary algorithm, the program flow may be started at step 1000. At step 1001, filtering may be performed in accordance with the disclosure herein (see, for example, the discussion associated with FIG. 5). For example, a plurality of thumbnail video transmissions (e.g., 50, 100, 150, 200, 500 or more) may be filtered by, any suitable criteria such as, for example, a program tier selected by the user, program guide channels selected by the user, an interactive theme selected by the user (action movies). Additional examples of filtration criteria are discussed herein.

At steps 1002 in this example, thumbnail video transmissions that may be selected in the filtering step (step 1001) (which is optional) may then be parsed into full and/or partial frames and/or macro blocks for later assembly into a mosaic in accordance with the disclosure herein. In this exemplary embodiment, the mosaic may be formed in accordance with system criteria, system capabilities, and/or the user's preferences. For example, the user's large screen television may be capable of displaying 10, 20, 30, 40, and/or 50 or more simultaneous thumbnail video screens. However, if the user switches to his/her I-pad, the system and/or user may choose only 4, 6, 8, 10, 14, 18, or 20 thumbnail videos to be displayed on one screen.

As discussed in more detail herein, at steps 1002-1003 in this example, the locations of the video transmissions (e.g., thumbnail videos) relative to each other may be organized and reordered in accordance with user preferences, system criteria, and/or display device capabilities. See, for example, the discussion associated herein with respect to FIGS. 4-7. In this example, the location of the full and/or partial macro blocks and/or full and/or partial frames of the video transmissions (e.g., thumbnail videos) may be arranged into a mosaic on the screen by interleaving the full and/or partial frames/macro blocks and/or reordering and/or address translation while the full and/or partial frames/macro blocks remain encoded (e.g., DCT encoded). In these embodiments, the video data itself (e.g., data that contains the pixel data for the dots on the screen, color information, etc. such as full and/or partial frames and/or macroblocks) can remain intact without a need to decode this data. Meanwhile the pixel reordering and screen address translation ensures that select thumbnail video transmissions can be displayed simultaneously. These may be displayed one thumbnail video after the other and/or may have border areas between the thumbnail videos. The number of macro blocks and/or frames, interleaving of the macro blocks and/or frames and/or address changes and/or translations may create the positioning of the different video transmissions in the mosaic.

In this example at step 1002-1003, a mosaic may be formed by organizing multiple thumbnail video transmissions by translating addresses and full and/or partial frame and/or macroblock location information to form a mosaic of the thumbnail videos composited onto one screen. This may be accomplished in this example without decoding the transmissions by reordering the full and/or partial frames and/or macroblocks and/or translating the location information associated with that frame and/or macroblock data without decoding the video data. This reordering and address translating can be accomplished, for example, on a standard central processing unit (CPU) without the need for decompression. For example, once the choice is made as to which videos transmissions (e.g., thumbnail videos) are to be displayed, and the order of the display, the parsing and the reordering of the frames can be done on the CPU by interleaving full and/or partial frames and/or macro blocks and/or with any associated address changes and/or translations.

As discussed herein, the filtration step (1001) may return more or less thumbnail videos than the screen will hold. For example, where less thumbnail videos are returned than the screen is set to display at that time, the thumbnail videos may be scaled up via interpolation or other suitable technique to make the thumbnails bigger and to fill the screen. In examples where more thumbnail videos are output from the filtering (e.g., step 1001) than the screen will hold, then in these examples it may be desirable to only display a portion of the thumbnail videos in the visible portion of the mosaic shown on the screen. In this example, steps 1002 and/or 1003 may be performed on the thumbnail video transmissions currently selected for display even though the filtration step may have returned more thumbnail video transmissions. The selection of which videos are shown on the initial visible portion of the screen may be user defined with certain channels, videos, genre, premium channels, actors, and/or source given a preference. Alternatively, the system may give certain channels preference such as those channels associated with a certain source and/or where additional channel revenue is paid to the associated cable/telecommunication/internet source. Once the initial screen is displayed, as discussed herein, in this example, the user may move among videos transmissions (e.g., thumbnail videos) on and off screen by moving the screen up, down, left, right, and/or at diagonals (e.g., by swiping the screen, remote control, and/or actuating a button on the remote control). In this example, as the user activates a user control to alter the thumbnail videos currently shown in the displayable area on the mosaic; steps 1002 and/or 1003 may be performed on the thumbnail video transmissions currently selected for display (e.g., after the user interaction) even though the filtration step may have returned other thumbnail video transmissions that are not currently shown in the visible mosaic displayed on the screen. Thus, the user may bring more of the mosaic into view using a screen movement control interface (e.g., swipes or key directional arrows). In the some embodiments, the video transmissions being parsed and assembled change as the user navigates around the mosaic to change which programs are currently in the visible portion of the mosaic. While all and/or many videos selected from the filtration may be parsed and assembled, it is often more efficient to parse and assemble just the visible portion of the mosaic and/or any thumbnail videos close to the visible portion of the mosaic. Selective parsing and assembling of thumbnail videos in and closely around the visible area is more efficient in terms of processor power and creates a video transmission (e.g., stream) that when decoded provides the visible display.

Referring to step 1004, active areas of the screen in this example may be associated with one or more video transmissions (e.g., thumbnail videos configured as streams). These active areas and/or video transmissions may also, in this example, be associated with: 1) one or more corresponding high definition videos, 2) program data, 3) program guide related data (e.g., channel, time, source, actors, genre, VOD, PPV data such as charges, video clips, ability to play from beginning, and/or other program guide related data), 4) video conference data (caller, location of caller, and/or capabilities of connection), and/or 5) other data relevant to the video transmission. For example, some of this information may be overlaid on the thumbnail video mosaic in any suitable arrangement. In exemplary arrangements, it may be overlaid on top of the thumbnail video. In other exemplary arrangements, it may be shown via one or more pop-up windows, overlays over other thumbnail videos, and/or overlays over the current video. Further, the selection of the thumbnail video in this example may replace the thumbnail video with one or more high definition video transmissions such as a high definition video corresponding to the thumbnail video. The active area, in this example, can also be used as a selection tool for additional supplemental information (e.g., program guide related data). For example, the active area may be selected as the thumbnail video area only and/or the active area may include both the thumbnail video area together with a portion of a border area separating the thumbnail videos.

Referring to step 1006, any transforms, special effects, resizing of pixels, addition of any boarders, transforming including mosaic warping (e.g., curvature in FIG. 5), 3D effects, and/or other processing may take place. Referring to FIG. 5 and step 1006, for example, the thumbnail videos may be spaced by inserting predefined macro blocks of (e.g. solid color) pixels in-between the thumbnail videos and/or around the thumbnail videos. Further, the macro blocks and/or thumbnail video frames may be warped and/or imposed on a 3D surface so that they are shown on a curvature such as a carousel or other curved image. Additionally, inverse image (e.g. mirror images, shadows, and/or over effects) may be added to the mosaic to heighten the appearance of the thumbnail program guide and/or video conference mosaic. See, for example, the bottom of FIG. 5 where mirror images of the bottom video transmissions are shown. This may be accomplished by applying mirror image and/or other transforms to macro blocks and then repeating the transformed macro block next to a non-translated macro blocks associated with a video transmission (e.g., thumbnail video). In this example, in step 1006, certain thumbnail videos may be resized as in FIG. 7, and/or overlaid as in FIG. 8.

Referring to step 1007, a user and/or system operator may modify the mosaic as desired. The user may turn on and/or off certain effects such as mirror images, shadows, boarders, 3d, and/or other effects. For example, a user may be given different themes which can be enable or disabled to better customize his thumbnail guide. The user may choose to resize one or more thumbnail videos. For example, one tap (or remote key press) may double the size of the thumbnail, another tap (or another remote key press) may show program guide information associated with the thumbnail video, and another tap (or another remote key press) may switch the video steam on the active screen area to full definition video (e.g., see steps 1008, 1009).

Again referring to step 1007, the user may refine the filtration step (1001) to return more or less videos based on alternate filtration criteria (e.g., alternate defined channels, premium videos, first runs, genre, premium channels, actors, and/or source). Once the initial screen is displayed, as discussed herein, in this example, the user may move among thumbnail videos on and off the active visible screen by moving the screen up, down, left, right, and/or at diagonals (e.g., by swiping the screen, remote control, and/or actuating a button on the remote control). Thus, certain thumbnail videos currently off screen can be brought into focus in the displayable active area of the screen. Further, the user may select less thumbnail videos on the screen by using a two finger action (expanding thumb and forefinger for example) and/or fewer videos on the screen by an opposite action (decreasing thumb and forefinger for example). The videos maybe scaled up or down to accomplish showing more or less thumbnail videos on the mosaic. Where a user selects a thumbnail video, the user may switch to a high definition video transmission (e.g., stream) associated with that thumbnail video (e.g., steps 1008, 1009). Alternately, the user may select to display one or more of program data, program guide related date (channel, time, source, actors, genre, VOD, PPV charges, video clips, ability to play from beginning, and/or other program guide related data), video conference data (caller, location of caller, and/or capabilities of connection), and/or other data relevant to the thumbnail video in a window (e.g. upper left, upper right, lower right, and/or lower left), one or more pop-up windows, and/or overlays. Further, the selection of the video transmission in this example may replace the thumbnail video with one or more high definition video transmissions such as a high definition video corresponding to the thumbnail video (e.g., steps 1008, 1009). The user may then select the movie of interest and may watch from the present time and/or may select that the transmission (e.g., stream) be sent from the beginning on a VOD channel.

In still alternate embodiments associated with FIG. 8, one or more steps (and/or portions of one or more steps) may be omitted and/or the steps may be performed in an order. Further, the example is not limiting in that some steps may be performed, some steps may be omitted, and some steps may be added in accordance with embodiments herein.

Although example embodiments are described above, the various features and steps may be combined, divided, omitted, and/or augmented in any desired manner, depending on the specific outcome and/or application. Various alterations, modifications, and improvements will readily occur to those skilled in art. Such alterations, modifications, and improvements as are made obvious by this disclosure are intended to be part of this description though not expressly stated herein, and are intended to be within the spirit and scope of the disclosure. Accordingly, the foregoing description is by way of example only, and not limiting. This patent is limited only as defined in the following claims and equivalents thereto.

We claim:

1. A method comprising:
receiving a plurality of video transmissions that have been compressed;
assembling a mosaic of at least some of the video transmissions while still compressed; and
decompressing the mosaic of the thumbnail video transmissions for display.

2. The method of claim 1 further comprising filtering the plurality of video transmissions to select the at least some of the video transmissions for inclusion in the mosaic.

3. The method of claim 2 further comprising filtering based on criteria specific to a particular user.

4. The method of claim 3 further comprising filtering based on user specified criteria.

5. The method of claim 1 further comprising assembling the plurality of video transmissions on frame boundaries.

6. The method of claim 1 further comprising assembling the plurality of video transmissions on macro block boundaries.

7. The method of claim 1 further comprising assembling the mosaic to include a picture in picture video display.

8. The method of claim 1 further comprising assembling the mosaic from a plurality of video transmissions which are thumbnail video streams.

9. The method of claim 1 further comprising assembling the mosaic including overlaying text.

10. A method comprising providing a software program configured for receiving a plurality of video transmissions that have been compressed, assembling a mosaic of the video transmissions while still compressed, and decompressing the mosaic of the thumbnail video transmissions for display.

11. The method of claim 10 wherein providing includes providing the software program configured for filtering the video transmissions.

12. The method of claim 11 wherein providing includes providing the software program configured for filtering the video transmissions based on criteria specific to a particular user.

13. The method of claim 10 wherein providing includes providing the software program configured for assembling frames of macroblock encoded data from different video transmissions.

14. The method of claim 10 wherein providing includes providing the software program configured for assembling the mosaic to include a picture in picture video display.

15. The method of claim 10 wherein providing includes providing the software program configured for assembling the mosaic from a plurality of video transmissions which are thumbnail videos.

16. The method of claim 10 wherein providing includes providing the software program configured for assembling the mosaic including overlaying text.

17. A method comprising:
simultaneously transmitting from a central communication system a plurality of video transmissions in a reduced definition macroblock encoded format; and
simultaneously transmitting information corresponding to the video transmissions for use as filtering criteria.

18. The method of claim 17 further comprising assembling the video transmissions into a mosaic while the video transmissions are still encoded.

19. The method of claim 18 further comprising filtering the video transmissions prior to assembling the video transmissions into a mosaic.

20. A method comprising simultaneously receiving a) a plurality of transmissions of full definition videos, b) a plurality of transmissions of macroblock encoded reduced definition videos corresponding to the plurality of transmissions of full definition videos, and c) information corresponding the plurality of transmissions of full definition videos, and encoding at least a subset of the plurality of transmissions of macroblock encoded reduced definition videos into a mosaic including at least some of the information.
